(19) United States
(12) Patent Application Publication
(10) Pub. No.: US 2013/0343105 A1
(43) Pub. Date: Dec. 26, 2013

(54) INVERTER OVERHEATING PROTECTION CONTROL APPARATUS AND INVERTER OVERHEATING PROTECTION CONTROL METHOD

(71) Applicant: Hajime Kosugi, Okazaki-shi (JP)

(72) Inventor: Hajime Kosugi, Okazaki-shi (JP)

(73) Assignee: TOYOTA JIDOSHA KABUSHIKI KAISHA, Toyota-shi, Aichi-ken (JP)

(21) Appl. No.: 13/982,163

(22) PCT Filed: Mar. 16, 2011
(86) PCT No.: PCT/JP2011/056208

§ 371 Date: Jul. 26, 2013

(51) Int. Cl. H02H 3/20

(52) U.S. Cl. CPC H02H 3/202
USPC 363/56.01

(57) ABSTRACT

An overheating protection control apparatus for an inverter driving a rotating electric machine comprising: a temperature sensor for measuring the temperature of a power control element in the inverter, and a control device restricting the load factor of the rotating electric machine when the temperature measured by the temperature sensor reaches a threshold value. The control device modifies the threshold value based on a parameter affecting heat radiation or cooling of the inverter. Preferably, the inverter includes a plurality of power control elements. The temperature sensor detects the temperature of one or more, but not all of the plurality of power control elements. The parameter is a physical quantity affecting the temperature difference between the one or more power control elements and another power control element included in the inverter. Preferably, the inverter is cooled by a coolant medium. The parameter is the temperature of the coolant medium.

### TECHNICAL FIELD

The present invention relates to an overheating protection control apparatus for an inverter, and an overheating protection control method for an inverter.

### BACKGROUND ART

Japanese Patent Laying-Open No. 03-003670 (PTL 1) discloses the technique of performing output current restriction control and associated reduction of output power when the value of a temperature sensor corresponding to an element or the like exceeds a predetermined value, as overheating protection control for an inverter.

### CITATION LIST

### Patent Literature

PTL 1: Japanese Patent Laying-Open No. 03-003670
PTL 2: Japanese Patent Laying-Open No. 2008-072818
PTL 3: Japanese Patent Laying-Open No. 2007-129801
PTL 4: Japanese Patent Laying-Open No. 2009-171766
PTL 5: Japanese Patent Laying-Open No. 2010-124594
PTL 6: Japanese Patent Laying-Open No. 2009-189181

### SUMMARY OF INVENTION

### Technical Problem

In accordance with the technique disclosed in the aforementioned Japanese Patent Laying-Open No. 03-003670, the load factor will be restricted with no exception when the value of the temperature sensor exceeds a predetermined threshold value.

Since an inverter has a certain size and the spot of the inverter where the temperature sensor can measure is only a representative spot, the measured spot will not necessarily match the spot of the inverter where the temperature is highest. In order to eliminate the occurrence of an overheated site from anywhere in the inverter regardless of the various changes in the operating state of the inverter, sufficient margin must be set for the threshold value.

This means that the load factor may be restricted even in the case where the operation is actually allowed without having to restrict the load factor. There may be a case where the performance of the inverter is not exhibited sufficiently.

An object of the present invention is to provide an overheating protection control apparatus for an inverter and an overheating protection control method for an inverter that allows the performance of the inverter to be exhibited sufficiently.

### Solution to Problem

The present invention is directed to an overheating protection control apparatus for an inverter driving a rotating electric machine. The overheating protection control apparatus includes a temperature sensor for measuring the temperature of a power control element in the inverter, and a control device restricting the load factor of the rotating electric machine when the temperature measured by the temperature sensor reaches a threshold value. The control device modifies the threshold value based on a parameter that affects heat radiation or cooling of the inverter.

Preferably, the inverter includes a plurality of power control elements. The temperature sensor detects the temperature of one or more but not all of the plurality of power control elements. The parameter includes a physical quantity affecting a temperature difference between the one or more power control elements and another power control element in the inverter.

More preferably, the inverter is cooled by a coolant medium. The parameter is the temperature of the coolant medium.

More preferably, the parameter includes any of a DC power supply voltage and a carrier frequency of the inverter.

More preferably, DC power supply voltage boosted by a boost converter is supplied to the inverter. The parameter includes any of a DC power supply voltage of the inverter, a carrier frequency of the inverter, a power supply voltage prior to being boosted by the boost converter, and a flowing current of the inverter.

According to another aspect, the present invention is directed to an overheating protection control method for an inverter driving a rotating electric machine. The method includes the steps of measuring the temperature of a power control element in the inverter, measuring a parameter differing from the temperature of the power control element in the inverter and that affects heat radiation or cooling of the inverter, modifying a threshold value based on the parameter, and restricting a load factor of the rotating electric machine when the measured temperature of the power control element in the inverter reaches the threshold value.

### Advantageous Effects of Invention

Since the load factor is restricted in accordance with the operating state of the inverter system in the present invention, the performance of the inverter can be exhibited sufficiently.

### BRIEF DESCRIPTION OF DRAWINGS

FIG. 1 is a circuit diagram representing a configuration of a vehicle 100 in which an inverter overheating protection control apparatus is mounted.

FIG. 2 is a circuit diagram representing a detailed configuration of inverters 14 and 22 in FIG. 1.

FIG. 3 is a circuit diagram representing a detailed configuration of a voltage converter 12 in FIG. 1.

FIG. 4 represents the arrangement of IGBT elements and temperature sensors of a PCU 240.

FIG. 5 is a block diagram in association with motor control of a control device 30 in FIG. 1.

FIG. 6 is a flowchart to describe a determination process of a load factor restriction start temperature Tps and motor drive control executed at a PM-ECU 32 and a MG-ECU 34 in FIG. 5.

FIG. 7 represents an exemplified study when load factor restriction start temperature Tps is set at a fixed value.

FIG. 8 is a diagram to describe a study of improving load factor restriction start temperature Tps.

FIG. 9 represents an improved load factor restriction start temperature Tps.

FIG. 10 represents an example of modifying load factor restriction start temperature Tps based on a carrier frequency fsw.

### DESCRIPTION OF EMBODIMENTS

Embodiments of the present invention will be described in detail hereinafter with reference to the drawings. In the drawings, the same or corresponding elements have the same reference characters allotted, and description thereof will not be repeated.

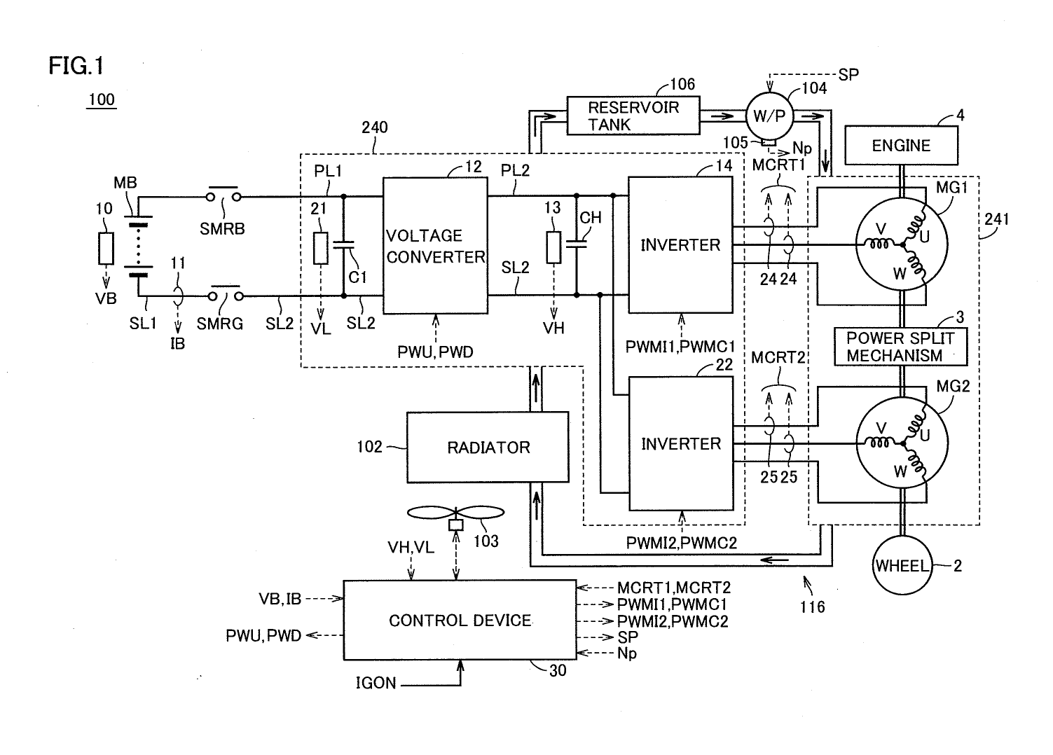

FIG. 1 is a circuit diagram representing a configuration of a vehicle 100 in which an inverter overheating protection control apparatus is mounted. Vehicle 100 is exemplified as a hybrid vehicle also incorporating an internal combustion engine. The present invention is also applicable to an electric vehicle and fuel cell vehicle, as long as the vehicle has an inverter mounted.

[Description of Vehicle Driving System]

Referring to FIG. 1, vehicle 100 includes a battery MB that is a power storage device, a voltage sensor 10, a power control unit (PCU) 240, a driving unit 241, an engine 4, a wheel 2, and a control device 30. Driving unit 241 includes motor generators MG1 and MG2, and a power split mechanism 3.

PCU 240 includes a voltage converter 12, smoothing capacitors C1 and CH, voltage sensors 13 and 21, and inverters 14 and 22. Vehicle 100 further includes a positive bus line PL2 and a negative bus line SL2 feeding power to inverters 14 and 22 driving motor generators MG1 and MG2, respectively.

Voltage converter 12 is provided between battery MB and positive bus line PL2 for voltage conversion. Smoothing capacitor C1 is connected between positive bus line PL1 and negative bus line SL2. Voltage sensor 21 detects a voltage VL across the terminals of smoothing capacitor C1 and provides the detected voltage to control device 30. Voltage converter 12 boosts the voltage across the terminals of smoothing capacitor C1.

Smoothing capacitor CH smoothes the voltage boosted by voltage converter 12. Voltage sensor 13 detects voltage VH across the terminals of smoothing capacitor CH for output to control device 30.

Inverter 14 converts the DC voltage applied from voltage converter 12 into 3-phase AC voltage for output to motor generator MG1. Inverter 22 converts the DC voltage applied from voltage converter 12 into 3-phase AC voltage for output to motor generator MG2.

Power split mechanism 3 is coupled to engine 4 and to motor generators MG1 and MG2 to split the power therebetween. For example, a planetary gear mechanism including three rotational shafts of a sun gear, a planetary carrier, and a ring gear may be employed as the power split mechanism. In the planetary gear mechanism, when the rotation of two of the three rotational shafts is determined, the rotation of the remaining one rotational shaft is inherently determined. These three rotational shafts are connected to each rotational shaft of engine 4, motor generator MG1 and motor generator MG2, respectively. The rotational shaft of motor generator MG2 is coupled to wheel 2 by means of a reduction gear and/or differential gear not shown. Furthermore, a reduction gear for the rotational shaft of motor generator MG2 may be additionally incorporated in power split mechanism 3.

Vehicle 100 further includes a system main relay SMRB connected between the positive electrode of battery MB and positive bus line PL1, and a system main relay SMRG connected between the negative electrode (negative bus line SL1) of battery MG and negative bus line SL2.

System main relays SMRB and SMRG have their conducting/non-conducting state controlled by a control signal applied from control device 30. Battery MB and converter 12 are connected by system main relays SMRB and SMRG.

Voltage sensor 10 measures a voltage VB of battery MB. A current sensor 11 detecting a current 1B flowing to battery MB is provided for the purpose of monitoring the charging state of battery MB together with voltage sensor 10. For battery MB, a secondary battery such as a lead battery, a nickel-metal hydride battery or a lithium ion battery, or a capacitor of large capacitance such as an electrical double layer capacitor may be employed.

Inverter 14 is connected to positive bus line PL2 and negative bus line SL2. Inverter 14 receives a voltage boosted from voltage converter 12 to drive motor generator MG1 for the purpose of, for example, starting engine 4. Furthermore, inverter 14 returns the power generated at motor generator MG1 by the power transmitted from engine 4 to voltage converter 12. At this stage, voltage converter 12 is under control of control device 30 so as to operate as a down-converting circuit.

Current sensor 24 detects the current flowing to motor generator MG1 as a motor current value MCRT1, which is output to control device 30.

Inverter 22 is connected to positive bus line PL2 and negative bus line SL2 in parallel with inverter 14. Inverter 22 converts DC voltage output from voltage converter 12 into 3-phase AC voltage for output to motor generator MG2 driving wheel 2. Furthermore, inverter 22 returns the power generated at motor generator MG2 to voltage converter 12 in accordance with regenerative braking. At this stage, voltage converter 12 is under control of control device 30 so as to operate as a down-converting circuit.

Current sensor 25 detects the current flowing to motor generator MG2 as a motor current value MCRT2, which is output to control device 30.

Control device 30 receives each torque command value and rotational speed of motor generators MG1 and MG2, each of the values of current IB and voltages VB, VL and VH, motor current values MCRT1 and MCRT2, and an activation signal IGON. Control device 30 outputs to voltage converter 12 a control signal PWU to effect a voltage boosting command, a control signal PWD to effect a voltage down-conversion command, and a shut down signal to effect an operation prohibition command.

Furthermore, control device 30 outputs to inverter 14 a control signal PWMI1 to effect a drive command for converting DC voltage that is the output from voltage converter 12 into an AC voltage directed to driving motor generator MG1, and a control signal PWMC1 to effect a regenerative command for converting the AC voltage generated at motor generator MG1 into DC voltage to be returned towards voltage converter 12.

Similarly, control device 30 outputs to inverter 22 a control signal PWMI2 to effect a drive command for converting the DC voltage into AC voltage directed to driving motor generator MG2, and a control signal PWMC2 to effect a regenerative command for converting the AC voltage generated at motor generator MG2 into DC voltage to be returned towards voltage converter 12.

[Description of Vehicle Cooling System]

Vehicle 100 includes, as the cooling system for cooling PCU 240 and driving unit 241, a radiator 102, a reservoir tank 106, and a water pump 104.

Radiator 102, PCU 240, reservoir tank 106, water pump 104 and driving unit 241 are connected in series in a circular manner through a water channel 116.

Water pump 104 serves to circulate a coolant such as anti-free fluid in the direction illustrated by the arrow. Radiator 102 receives the coolant subsequent to cooling voltage converter 12 and inverter 14 in PCU 240 from the water channel to cool the received coolant.

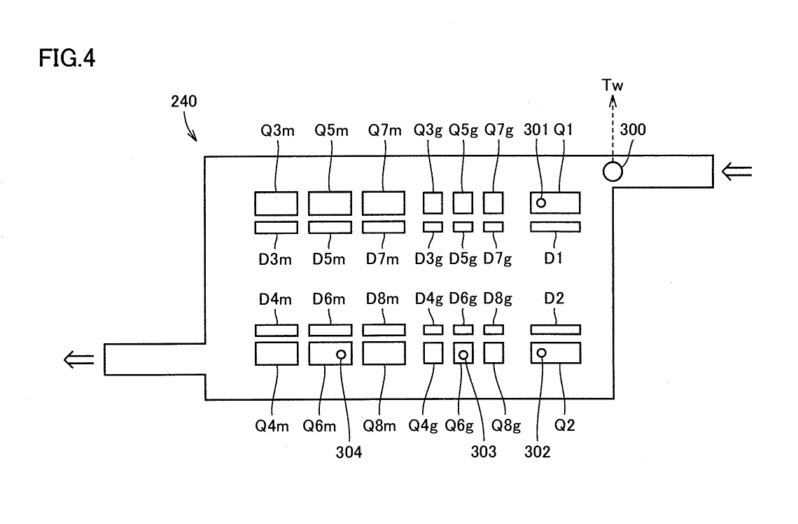

As will be described afterwards with reference to FIG. 4, a temperature sensor 300 measuring the temperature of the coolant, temperature sensors 301 and 302 detecting the temperature of voltage converter 12, and temperature sensors 303 and 304 detecting the temperature of inverters 14 and 22, respectively, are provided in the configuration of FIG. 1.

Based on an output from the temperature sensors, control device 30 generates a signal SP directed to driving water pump 104, and provides the generated signal SP to water pump 104. Based on the output of the temperature sensors, control device 30 executes overheating protection control such that voltage converter 12 and inverters 14 and 22 are not overheated.

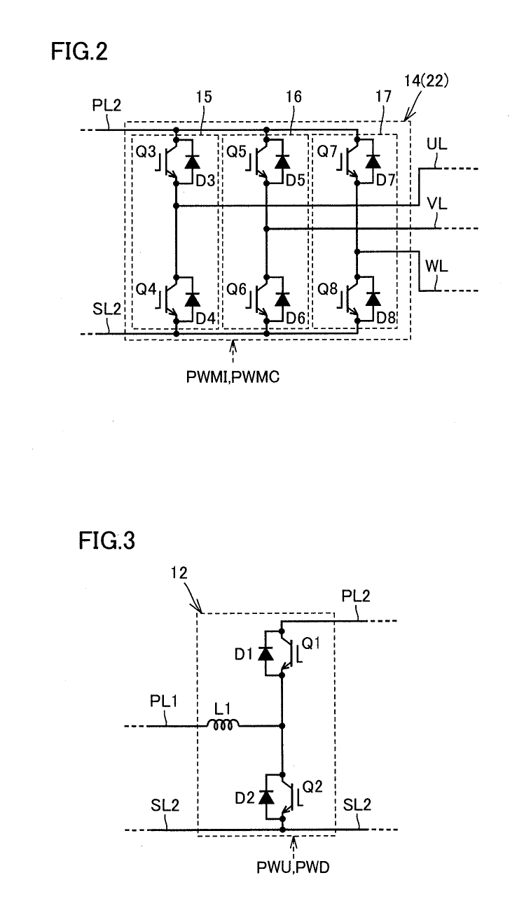

FIG. 2 is a circuit diagram representing a detailed configuration of inverters 14 and 22 in FIG. 1.

Referring to FIGS. 1 and 2, inverter 14 includes a U-phase arm 15, a V-phase arm 16, and a W-phase arm 17. U-phase arm 15, V-phase arm 16 and W-phase arm 17 are connected in parallel between positive bus line PL2 and negative bus line SL2.

U-phase arm 15 includes IGBT elements Q3 and Q4 connected in series between positive bus line PL2 and negative bus line SL2, and diodes D3 and D4 connected in parallel with IGBT elements Q3 and Q4, respectively. Diode D3 has its cathode connected to the collector of IGBT element Q3, and its anode connected to the emitter of IGBT element Q3. Diode D4 has its cathode connected to the collector of TGBT element Q4, and its anode connected to the emitter of TGBT element Q4.

V-phase arm 16 includes IGBT elements Q5 and Q6 connected in series between positive bus line PL2 and negative bus line SL2, and diodes D5 and D6 connected in parallel with IGBT elements Q5 and Q6, respectively. Diode D5 has its cathode connected to the collector of IGBT element Q5 and its anode connected to the emitter of IGBT element Q5. Diode D6 has its cathode connected to the collector of IGBT element Q6, and its anode connected to the emitter of IGBT element Q6.

W-phase arm 17 includes IGBT elements Q7 and Q8 connected in series between positive bus line PL2 and negative bus line SL2, and diodes D7 and D8 connected in parallel with IGBT elements Q7 and Q8, respectively. Diode D7 has its cathode connected to the collector of IGBT element Q7, and its anode connected to the emitter of IGBT element Q7. Diode D8 has its cathode connected to the collector of IGBT element Q8, and its anode connected to the emitter of IGBT element Q8.

The intermediate point of each phase arm is connected to each phase end of each phase coil of motor generator MG1. Specifically, motor generator MG1 is a 3-phase permanent magnet synchronous motor. The three coils of the U, V and W-phase have each one end connected together to the neutral point. The other end of the U-phase coil is connected to a line UL drawn out from the connection node of IGBT elements Q3 and Q4. The other end of the V-phase coil is connected to a line VL drawn out from the connection node of IGBT elements Q5 and Q6. The other end of the W-phase coil is connected to a line WL drawn out from the connection node of IGBT elements Q7 and Q8.

Inverter 22 of FIG. 1 is similar to inverter 14 as to the internal circuit configuration, provided that it is connected to motor generator MG2. Therefore, detailed description thereof will not be repeated. For the sake of simplification, FIG. 2 is depicted with control signals PWMI and PWMC applied to the inverter. Different control signals PWMI1 and PWMC1, and control signals PWMI2 and PWMC2 are applied to inverters 14 and 22, respectively, as shown in FIG. 1.

FIG. 3 is a circuit diagram representing a detailed configuration of voltage converter 12 of FIG. 1.

Referring to FIGS. 1 and 3, voltage converter 12 includes a reactor L1 having one end connected to positive bus line PL1, IGBT elements Q1 and Q2 connected in series between positive bus line PL2 and negative bus line SL2, and diodes D1 and D2 connected in parallel with IGBT elements Q1 and Q2, respectively.

Reactor L1 has the other end connected to the emitter of IGBT element Q1 and the collector of IGBT element Q2. Diode D1 has its cathode connected to the collector of IGBT element Q1 and its anode connected to the emitter of IGBT element Q1. Diode D2 has its cathode connected to the collector of IGBT element Q2 and its anode connected to the emitter of IGBT element Q2.

FIG. 4 represents an arrangement of IGBT elements and temperature sensors of PCU 240.

Referring to FIG. 4, a coolant flows into the cooling channel of the casing of PCU 240, as indicated by the top right arrow, and flows out as indicated by the bottom left arrow after passing through the cooling channel of the casing of PCU 240.

PCU 240 has temperature sensor 300 provided in the neighborhood of the inlet of the coolant. Temperature sensor 300 outputs a coolant temperature Tw to control device 30. The PCU casing has arranged, from the coolant inlet towards the outlet, IGBT elements Q1 and Q2 and diodes D1 and D2 of voltage converter 12, IGBT elements Q3g-Q8g and diodes D3g-D8g of inverter 14, and IGBT elements Q3m-Q8m and diodes D3m-D8m of inverter 22, in the cited order. PCU 240 also has temperature sensors 301-304 provided. For voltage converter 12, temperature sensor 301 is provided in proximity to IGBT element Q1 whereas temperature sensor 302 is provided in proximity to IGBT element Q2. For inverters 14 and 22, temperature sensor 303 is provided in proximity to IGBT element Q6g, whereas temperature sensor 304 is provided in proximity to IGBT element Q6m.

Since PCU 240 has a certain size and the spots where temperature sensors 301-304 can measure are only representative spots, the measured spots will not necessarily match the spot of PCU 240 where the temperature is highest. Therefore, the temperature threshold value to initiate load factor restriction is determined such that none of the elements attains an overheated state regardless of the various changes in the operating state of inverters 14 and 22 as well as voltage converter 12. However, if the margin provided is too great between the element heat-resisting temperature and the temperature threshold value, load factor restriction will occur frequently such that the performance of the inverter cannot be exhibited sufficiently.

The present embodiment is directed to modifying the temperature threshold value based on the operating state of the inverter and/or voltage converter.

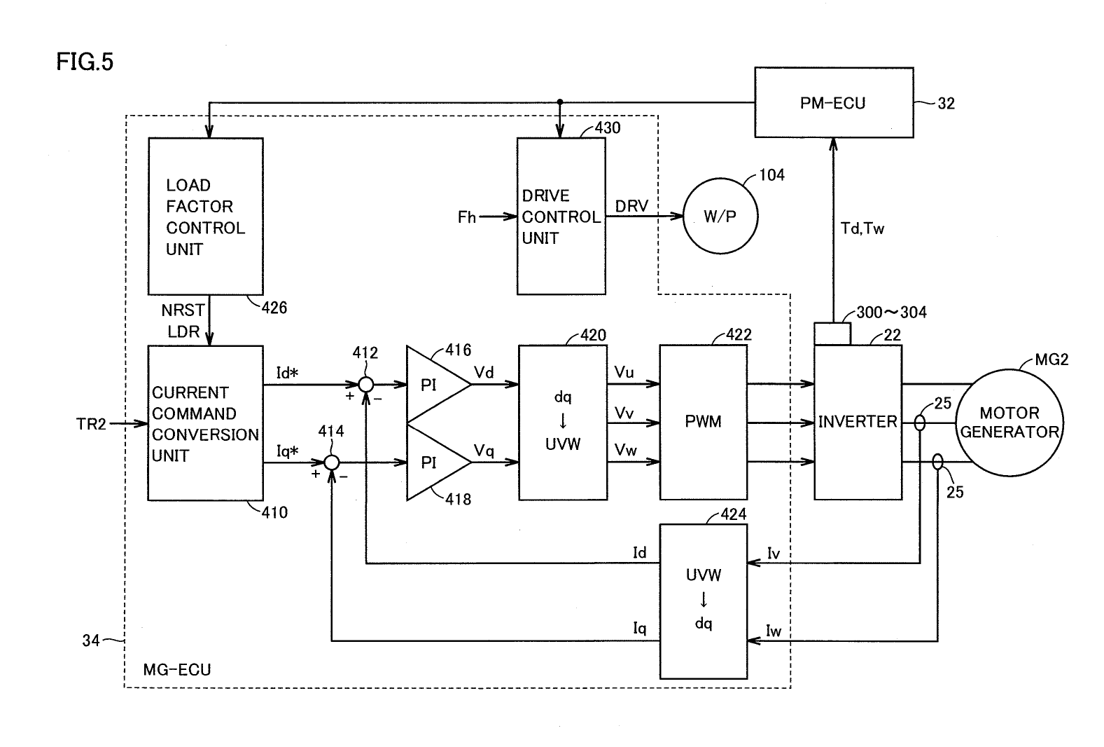

FIG. 5 is a block diagram associated with motor control of control device 30 in FIG. 1.

Referring to FIG. 5, control device 30 includes a power management ECU (hereinafter, PM-ECU) 32, and a motor generator control ECU (hereinafter, MG-ECU) 34. MG-ECU 34 includes a control circuit for inverter 22 driving motor generator MG2 that is a driving motor, a control circuit (not shown) for inverter 14 driving motor generator MG1, and a drive control unit 430 for controlling the drive of water pump 104.

The inverter control circuit includes a 3-phase/2-phase conversion unit 424, a load factor control unit 426, a current command conversion unit 410, subtracters 412 and 414, PI control units 416 and 418, a 2-phase/3-phase conversion unit 420, and a PWM generation unit 422.

3-phase/2-phase conversion unit 424 receives motor currents Iv and Iw from two current sensors 25. 3-phase/2-phase conversion unit 424 calculates motor current Iu=−Iv−Iw based on motor currents Iv and Iw.

3-phase/2-phase conversion unit 424 converts the three phases of motor currents Iu, Iv and Iw into 2 phases using a degree of rotation θ from a rotation speed sensor not shown. In other words, 3-phase/2-phase conversion unit 424 converts the 3-phase motor currents Iu, Iv and Iw flowing through each phase of the 3-phase coils of motor generator MG2 into current values Id and Iq flowing to the d axis and q axis using a degree of rotation θ. 3-phase/2-phase conversion unit 424 outputs the calculated current values Id and Iq to subtracter 412 and subtracter 414, respectively.

PM-ECU 32 receives element temperature Td and coolant temperature Tw from temperature sensors 300-304 provided at PCU 240 described with reference to FIG. 4 to provide a load factor restriction command of motor generator MG2 to load factor control unit 426, and a driving command of water pump 104 to drive control unit 430.

When inverter element temperature Td is higher than load factor restriction start temperature Tps, PM-ECU 32 outputs a load factor restriction command to load factor control unit 426 to restrict the driving current supplied to motor generator MG2 from inverter 22. In response to receiving a load factor restriction command from PM-ECU 32, load factor control unit 426 sets load factor LDR of motor generator MG2. Load factor control unit 426 outputs the set load factor LDR to current command conversion unit 410.

Current command conversion unit 410 receives a torque command value TR2 from an external ECU, and receives a signal NRST or load factor LDR from load factor control unit 426. Current command conversion unit 410 generates, in response to receiving signal NRST from load factor control unit 426, current commands Id* and Iq* to output torque specified by torque command value TR2.

Upon receiving load factor LDR from load factor control unit 426, current command conversion unit 410 multiplies torque command value TR2 by load factor LDR to calculate a restriction torque command value TRR. Current command conversion unit 410 generates current command Id* and Iq* to output the torque specified by restriction torque command value TRR. Current command conversion unit 410 outputs the generated current commands Id* and Iq* to subtracters 412 and 414, respectively.

Subtracter 412 calculates the deviation between current command Id* and current value Id (=Id*−Id), and provides the calculated deviation to PI control unit 416. Subtracter 414 calculates the deviation between current command Iq* and current value Iq (=Iq*−Iq) to provide the calculated deviation to PI control unit 418.

PI control units 416 and 418 calculate the voltage control amounts Vd and Vq for adjusting the motor current using the PI gain to the deviations Id*−Id, Tq*−Tq, and provides the calculated voltage control amounts Vd and Vq to 2-phase/3-phase conversion unit 420.

2-phase/3-phase conversion unit 420 converts the voltage control amounts Vd and Vq from PI control units 416 and 418 into 3-phase signals from 2-phase signals using degree of rotation θ from the rotational speed sensor. In other words, 2-phase/3-phase conversion unit 420 converts voltage control amounts Vd and Vq applied to the d axis and q axis into voltage control amounts Vu, Vv and Vw applied to the 3-phase coils of motor generator MG2 using degree of rotation θ. 2-phase/3-phase conversion unit 420 provides voltage control amounts Vu, Vv and Vw to PWM generation unit 422.

PWM generation unit 422 generates a signal PWMI2 based on voltage control amounts Vu, Vv, and Vw, and input DC current voltage VH of inverter 22 to provide the generated signal PWMI2 to inverter 22.

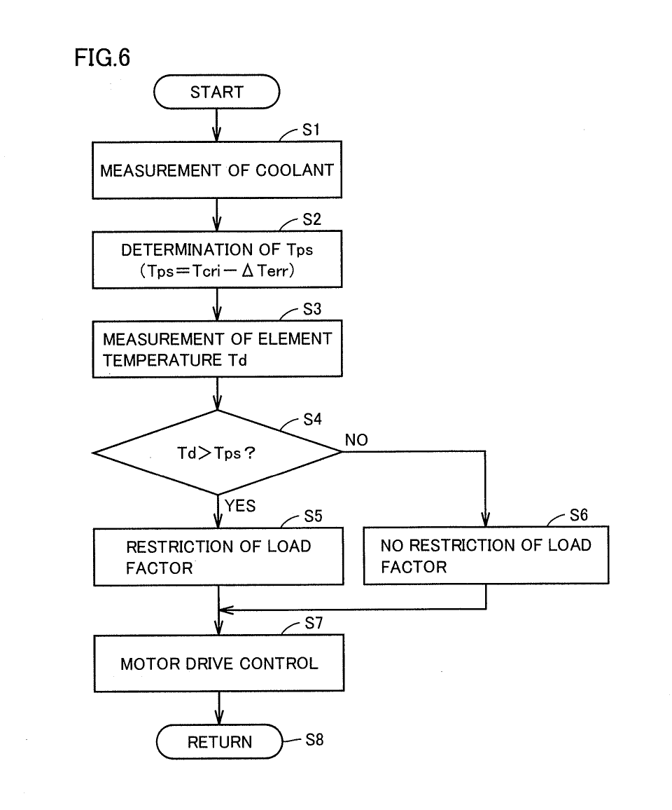

FIG. 6 is a flowchart to describe a determination process of load factor restriction start temperature Tps and motor drive control executed at PM-ECU 32 and MG-ECU 34 of FIG. 5. The process of this flowchart is invoked from the main routine to be executed at a predetermined interval or every time a predetermined condition is met.

When the process of FIG. 6 is started, temperature sensor 300 of FIG. 4 measures coolant temperature Tw at step S1. At step S2, PM-ECU 32 determines load factor restriction start temperature Tps. Load factor restriction start temperature Tps is determined by the following equation (1).

Tps=Tcri−ΔTerr (1)

where Tcri represents the element heat-resisting temperature of the IGBT element, and ΔTerr represents the worst case value in the variation of the temperature increase between an IGBT element having the temperature measured and an IGBT element not having the temperature measured. Load factor restriction start temperature Tps will be described in detail hereinafter with reference to the drawing.

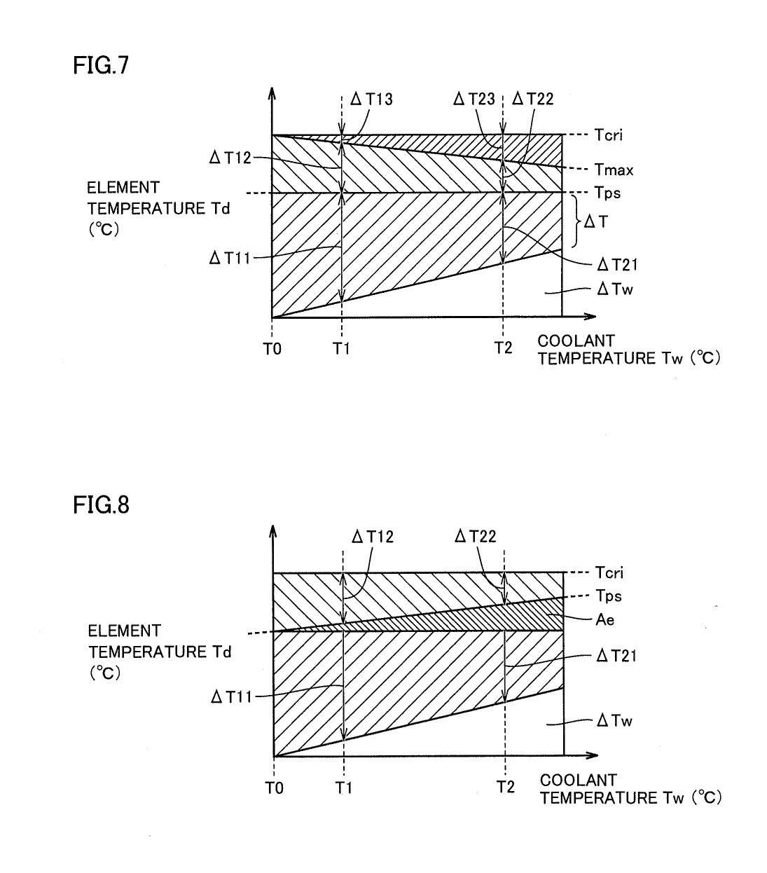

FIG. 7 represents an exemplified study when load factor restriction start temperature Tps is set at a fixed value.

In FIG. 7, element temperature Td is plotted along the vertical axis whereas coolant temperature Tw is plotted along the horizontal axis. Load factor restriction start temperature Tps is set at a value having a constant margin to element heat-resisting temperature Tcri. In FIG. 7, load factor restriction start temperature Tps takes the same value even if coolant temperature Tw changes.

Only a representative element in the inverter has its temperature measured, and a determination is made as to whether load factor restriction is to be executed or not in view of a load factor restriction initiation condition based on the measured temperature. However, since the temperature of all the elements is not measured, as shown in FIG. 4, there is variation in the temperature difference between an element having its temperature measured and an element not having its temperature measured. A value taking into account the variation is subtracted from element heat-resisting temperature Tcri and the subtracted result is taken as load factor restriction start temperature Tps. Accordingly, the maximum value Tmax of the element temperature matches element heat-resisting temperature Teri or is in the range of Tcri to Tps.

The variation factor between elements includes: a) element loss variation (caused by variation in each property of the gate threshold voltage, gate resistance, and switching time); b) variation in heat resistance (void in solder or the like, coolant flow, coolant temperature distribution and the like); c) degradation in heat resistance; and d) variation between temperature sensors. Among these variation factors, the absolute value of a, b and c varies depending upon the element temperature increase ΔT. The absolute values of a, b and c tend to become larger as ΔT increases.

When load factor restriction start temperature Tps is determined based on coolant temperature Tw=T0 as the reference in FIG. 7, ΔT=T11 at coolant temperature Tw=T1 and ΔT=T21 at coolant temperature Tw=T2, resulting in a smaller ΔT. Accordingly, the aforementioned variation factors a, b and c become smaller. Representing the element highest temperature taking into consideration the element variation when the load factor is to be restricted, element variation Tmax-Tps becomes smaller as coolant temperature Tw becomes higher, as ΔT12 and ΔT22. Therefore, the region indicated at ΔT13 and ΔT23 when coolant temperature Tw=T1 and Tw=T2, respectively, is the excessive margin region. It is appreciated that the element performance is not exploited effectively when the coolant temperature is high. The present invention is devised to exploit the performance of the element to the maximum level, and prevent unnecessary load factor restriction.

FIG. 8 is a diagram to describe a study of improving load factor restriction start temperature Tps.

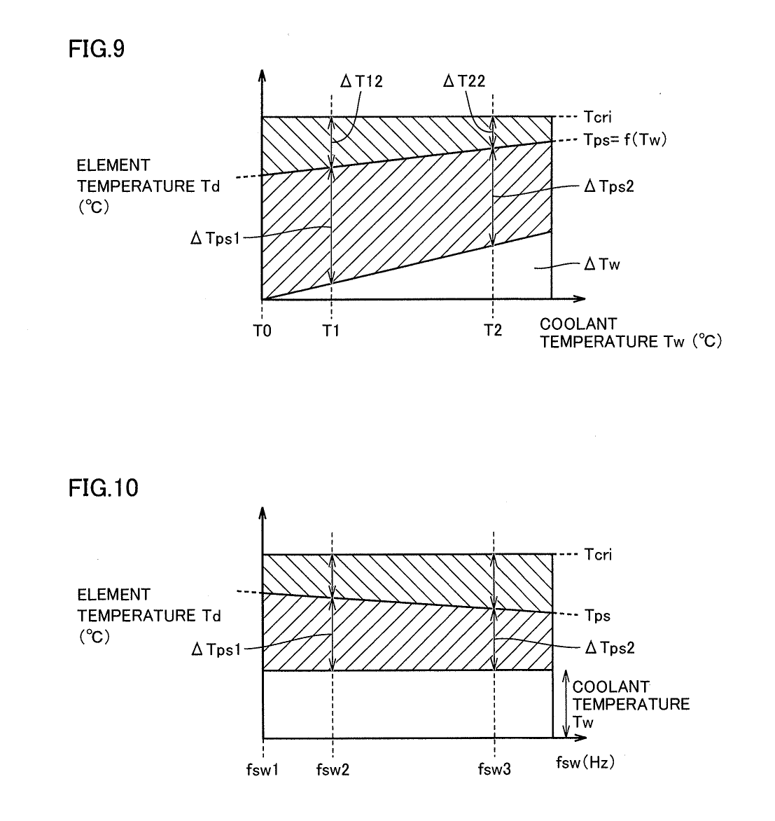

FIG. 9 represents an improved load factor restriction start temperature Tps. Referring to FIG. 8, at coolant temperature Tw=T1, element heat-resisting temperature Tcri minus variation ΔT12 is set for Tps. At coolant temperature Tw=T2, element heat-resisting temperature Tcri minus variation ΔT22 is set for Tps. Thus, region Ae represents the region where the introduction of load factor restriction can be avoided by applying the art of the present embodiment.

The reason why such modification is allowed will be described hereinafter. The element heat-resisting protection requirement corresponds to the establishment of equation (2) set forth below. Teri represents the element heat-resisting temperature, Tps the load factor restriction start temperature, and ΔTerr the temperature variation between elements (worst case value).

Tcri>(Tps+ΔTerr) (2)

ΔTerr is represented by the following equation (3), where α represents the part in accordance with ΔT (=the increase of the element temperature from coolant temperature), and β represents a constant.

ΔTerr=α+β (3)

Therefore, when ΔT is small (high coolant temperature), ΔTerr is small since a, becomes smaller. Therefore, equation (2) is established even if Tps is increased. As a result, as shown in FIG. 9, load factor restriction start temperature Tps is to be determined as a function of coolant temperature Tw, such as Tps=f (Tw). More specifically, load factor restriction start temperature Tps is determined to become higher as the coolant temperature rises.

α and β in equation (3) can be represented as set forth below according to the aforementioned element variation factors of a) element loss variation, b) heat resistance variation, c) degradation in heat resistance, and d) variation between temperature sensors. “A” represents a coefficient.

α=A(a+b+c)×ΔT (4)

β=d (5)

By equations (2)-(4), Tps corresponding to the boundary condition of Equation (2) is obtained.

$$\begin{matrix}Tps = f ( Tw ) \\ = Tcri - Δ Terr \\ = Tcri - α - β \\ = Tcri - A ( a + b + c ) \times Δ T - d\end{matrix}$$

By further inserting ΔT=Tps−Tw,

Tps=Tcri−A(a+b+c)×(Tps−Tw)−d.

By solving this equation for Tps, the following equation (6) can be derived.

Tps=(Tcri+A(a+b+c)×Tw−d)/(1+A(a+b+c)) (6)

Referring to FIG. 6 again, following the determination of load factor restriction start temperature Tps at step S2, control proceeds to step S3 where element temperature Td is measured. Element temperature Td is determined based on the outputs from temperature sensors 301-304 of FIG. 4. The output of any one temperature sensor may be used as a representative thereof, or an average value and the like may be used.

At step S4, a determination is made as to whether element temperature Td exceeds load factor restriction start temperature Tps. When Td>Tps is met at step S4, control proceeds to step S5, otherwise, control proceeds to step S6. At step S6, a determination is made that load factor restriction is not performed.

In this case, motor generator MG2 is driven based on torque command value TR2 at step S7. In FIG. 5, signal NRST is output from load factor control unit 426, and current command conversion unit 410 generates a motor current command based on torque command value TR2.

In contrast, at step S5, a determination is made that load factor restriction is to be performed. In this case, control proceeds to step S7 where a motor current command is generated based on a value (restriction torque command value TRR) corresponding to torque command value TR2 multiplied by load factor LDR, as described for current command conversion unit 410 in FIG. 5. The torque restriction executed at step S7 may be carried out by another way as long as the restriction to prevent exceeding element heat-resisting temperature Teri is effected, such as lowering the upper limit of the torque command.

Following the execution of motor drive control at step S7, control proceeds to step S8 for transition to the main routine.

In the present embodiment, load factor restriction start temperature Tps is variable, and set based on coolant temperature Tw, as set forth above. Accordingly, the performance of the inverter can be exhibited sufficiently, increasing the operable range without the load factor being restricted at high temperature. The frequency of load factor restriction occurring is reduced, allowing an operation in which the performance of the vehicle is exhibited sufficiently.

### Another Modification Example

FIGS. 7-9 have been described based on the case where load factor restriction start temperature Tps is set based on coolant temperature Tw. Load factor restriction start temperature Tps may be set based on another parameter. This parameter includes various items as long as it is a physical quantity affecting heat radiation or cooling of the inverter. For the parameter, carrier frequency fsw of the inverter, inverter voltage VH (voltage after boosting), converter input voltage VL (voltage before boosting), and flowing current Irms (battery current IB, inverter currents MCRT 1 and MCRT2, or the like) can be cited.

FIG. 10 represents an example of load factor restriction start temperature Tps being modified based on carrier frequency fsw.

In FIG. 10, element temperature Td is plotted along the vertical axis whereas the inverter carrier frequency fsw is plotted along the horizontal axis. The heat radiation from an IGBT element becomes greater as carrier frequency fsw becomes higher. The variation between elements is also increased as the heat radiation becomes greater. Therefore, the margin with respect to element heat-resisting temperature Tcri must be increased as the carrier frequency becomes higher from fsw1 to fsw2 and to fsw3. Thus, load factor restriction start temperature Tps is set lower as the carrier frequency becomes higher in FIG. 10.

For the purpose of taking into consideration other parameters, a function with VH, VL, fsw and Irms as parameters may be determined such as load factor restriction start temperature Tps=f1(VH, VL, fsw, Irms).

α and β in Equation (3) can be set as set forth below. For a-d, various variations are indicated, likewise with Equation (4). A1 represents a coefficient.

α=A1(a+b+c)×f1(VH,VL,fsw,Irms) (7)

β=d (8)

By Equations (2), (3), (7) and (8), Tps corresponding to the boundary condition of Equation (2) is obtained.

$$\begin{matrix}Tps = f ( VH , VL , fsw , Irms ) \\ = Tcri - Δ Terr \\ = Tcri - α - β \\ = Tcri - A 1 ( a + b + c ) \times f 1 ( VH , VL , fsw , Irms ) - d\end{matrix}$$

The value determined by the equation set forth above is to be taken as load factor restriction start temperature Tps. A map with VH, VL, fsw and Irms as parameters may be determined based on experimental results. Moreover, a combination of coolant temperature in addition to these parameters may be taken into account.

It should be understood that the embodiments disclosed herein are illustrative and non-restrictive in every respect. The scope of the present invention is defined by the terms of the claims, rather than the description of the embodiments set forth above, and is intended to include any modifications within the scope and meaning equivalent to the terms of the claims.

### REFERENCE SIGNS LIST

2 wheel; 3 power split mechanism; 4 engine; 10, 13, 21 voltage sensor; 11, 24, 25 current sensor; 12 voltage converter; 14, 22 inverter; 30 control device; 100 vehicle; 102 radiator; 104 water pump; 106 reservoir tank; 116 water channel; 241 driving unit; 300-304 temperature sensor; 410 current command conversion unit; 412, 414, 412, 414 subtracter; 416, 418, 416, 418 control unit; 420 2-phase/3-phase conversion unit; 424 3-phase/2-phase conversion unit; 422 PWM generation unit; 426 load factor control unit; 430 drive control unit; C1, CH smoothing capacitor; D1-D8, D3g-D8g, D3m-D8m diode; 32 power management ECU; 34 motor generator control ECU; L1 reactor; MB battery; MG1, MG2 motor generator; PL1, PL2 positive bus line; Q1-Q8, Q3g-Q8g, Q3m-Q8m IGBT element; SL1, SL2 negative bus line; SMRB, SMRG system main relay.

1. An overheating protection control apparatus for an inverter driving a rotating electric machine, comprising:
a temperature sensor measuring a temperature of a power control element of said inverter, and
a control device restricting a load factor of said rotating electric machine when the temperature measured by said temperature sensor reaches a threshold value,
said control device modifying said threshold value based on a parameter affecting heat radiation or cooling of said inverter, and
said parameter including any of a DC power supply voltage and carrier frequency of said inverter.

2. The overheating protection control apparatus for an inverter according to claim 1, wherein
said inverter includes a plurality of power control elements,
said temperature sensor detects the temperature of one or more but not all of said plurality of power control elements, and
said parameter is a physical quantity affecting a temperature difference between said one or more power control elements and another power control element included in said inverter.

3. (canceled)

4. (canceled)

5. The overheating protection control apparatus for an inverter according to claim 2, wherein
said inverter is supplied with a DC power supply voltage boosted by a boost converter,
said parameter includes any of a DC power supply voltage of said inverter, a carrier frequency of said inverter, a power supply voltage prior to being boosted by said boost converter, and a flowing current of said inverter.

6. An overheating protection control method for an inverter driving a rotating electric machine, comprising the steps of:
measuring a temperature of a power control element in said inverter,
measuring a parameter affecting heat radiation or cooling of said inverter, said parameter differing from the temperature of a power control element in said inverter,
modifying a threshold value based on said parameter, and
restricting a load factor of said rotating electric machine when the measured temperature of the power control element of said inverter reaches said threshold value,
said parameter including any of a DC power supply voltage and carrier frequency of said inverter.
